(19) United States
(12) Patent Application Publication
(10) Pub. No.: US 2003/0013494 A1
(43) Pub. Date: Jan. 16, 2003

(54) Mobile radio terminal equipment

(76) Inventor: Shigeru Imura, Tokyo (JP)

Correspondence Address: COOPER & DUNHAM LLP, 1185 Avenue of the Americas, New York, NY, 10036, US

(21) Appl. No.: 10/189,831

(22) Filed: May 22, 2002

(30) Foreign Application Priority Data
May 31, 2001 (JP) P2001-165189

(51) Int. Cl. H04B 1/18; H04M 1/00; H04B 1/38

(52) U.S. Cl. 455/566; 455/550; 455/575; 455/158.2

(57) ABSTRACT

Mobile radio terminal equipment such as a mobile phone with a clock function in which, if a time difference is detected, the time indication is automatically changed to enable the user to recognize the time difference easily. When a user of mobile radio terminal equipment moves to a place where there is a time difference from the basic time for him/her, the time difference is detected using the area code sent from a base station or the caller number from the other party's terminal equipment. After that, the time display is automatically changed to the mode where both Home time (usual clock time) and Local time (time which reflects the time difference) are displayed simultaneously.

### BACKGROUND OF THE INVENTION

1. Field of the Invention

The present invention relates to mobile radio terminal equipment and particularly to mobile radio terminal equipment which is suitable for use as a mobile phone.

2. Description of Related Art

At present, the European digital car-phone/mobile phone system GSM (Global System for Mobile Communication) is widely used not only in Europe but also in many other countries and may be considered as a de facto global standard.

On the other hand, there are time differences throughout the world. The standard time for each country or region is determined based on the international standard time (GMT=UTC). Users of the above system often use their mobile radio terminal equipment outside of the area covered by the standard time for their country or region (this area is called a “Home City”).

With this background, mobile radio terminal equipment based on the above system which has means to display on its display two types of time—time in the user's Home City and time in an area other than the Home City, for example, what is called a World City (such an area is hereinafter called a “World City”)—has been proposed and introduced into the market.

In setting the Home City time or World city time to be displayed, the user has to select the time setting function from the menu in the mobile radio terminal equipment and enter time data taking the time difference into consideration. In order to relieve the user of this troublesome task, a mobile phone set in which a clock time is automatically set has been proposed, for example, in JP-A-079194/1995.

However, the above-mentioned mobile radio terminal equipment has the following problem. Namely, the time setting procedure and discrimination of time may be complicated because there are a plurality of clock time candidates.

### SUMMARY OF THE INVENTION

Accordingly, it is an object of the present invention to provide mobile radio terminal equipment having a plurality of clock time candidates that allows easy time setting and time discrimination to increase convenience for the user.

In carrying out our invention in one preferred mode, we utilize mobile radio terminal equipment with a built-in clock for time display, comprising: basic time storage means for storing basic time information; display means for displaying time; recognition means for recognizing time information for the current location of the mobile radio terminal equipment; recognized time storage means for storing the time information recognized by the recognition means; detection means for comparing the time information stored by the basic time storage means with the time information stored by the recognized time storage means and detecting a time difference if any; and control means for performing automatic control so as to display on the display means both the basic time information and the time information for the current location when a time difference is detected by the detection means.

In mobile radio terminal equipment configured as mentioned above according to the present invention, basic time information is stored; time information for the current location of the mobile radio terminal equipment in use is recognized and stored; and a comparison is made between both time information to detect a time difference if any. The time display on the mobile radio terminal equipment is controlled so that both times are displayed automatically when a time difference is detected. In this way, when there is a time difference from the basic time, time information is given with consideration to the time difference.

Other and further objects, features and advantages of the invention will appear more fully from the following description.

### BRIEF DESCRIPTION OF THE DRAWINGS

In the attached drawings:

FIG. 1 is a schematic diagram showing an example of a digital cellular system;

FIG. 2 is a block diagram showing the structure of a mobile phone;

FIG. 3 shows an example of a time display screen which usually appears;

FIG. 4 shows an example of a time display screen which appears after automatic time display change according to the present invention;

FIG. 5 illustrates an example of LAI specification;

FIG. 6 illustrates an example of IMSI specification;

FIG. 7 is an example of a time difference table;

FIG. 8 is a flowchart showing an example of a World Clock time setting and display operation sequence according to an embodiment of the present invention; and

FIG. 9 is a flowchart showing an example of a Home Clock time setting operation sequence according to an embodiment of the present invention.

### DETAILED DESCRIPTION OF THE PREFERRED EMBODIMENTS

A preferred embodiment of the present invention will be described referring to the accompanying drawings.

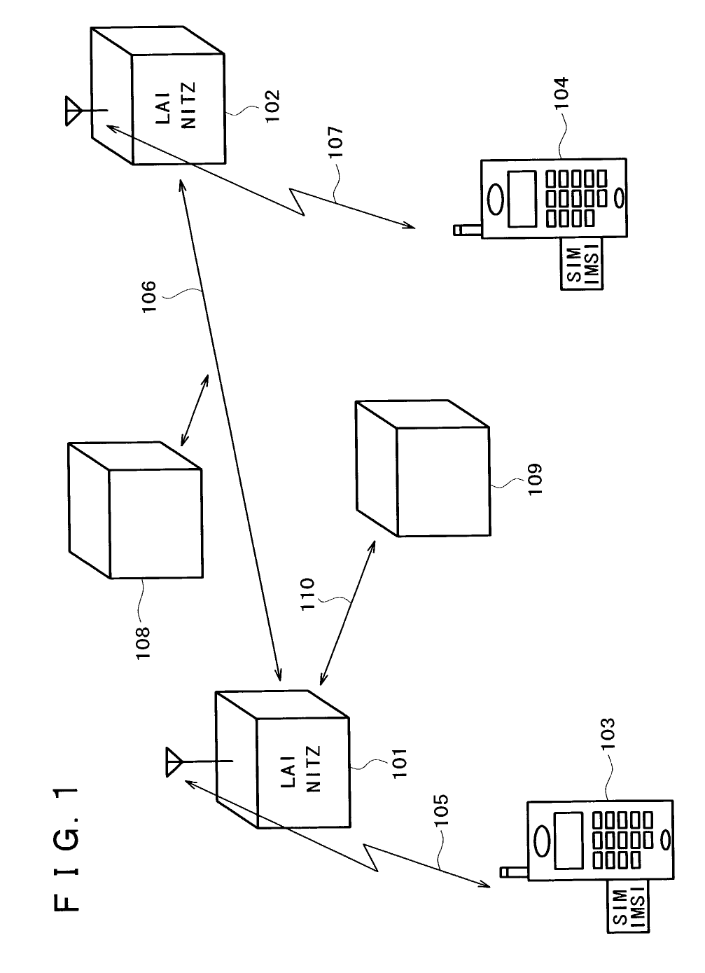

FIG. 1 is a general schematic diagram showing an example of a digital cellular system, namely mobile radio terminal equipment linked to a communication network.

As shown in FIG. 1, to make a call from a mobile phone 103 to a mobile phone 104, first of all the mobile phone 103 sends updated information on its location to a mobile phone base station 101 via an air interface 105.

In return, the mobile phone base station 101 sends the mobile phone 103 LAI (Location Area Identification) and NITZ (Network Information & Timezone) information as part of the information which the mobile phone base station has. For authentication, the mobile phone 103 sends the mobile phone base station 101 IMSI (International Mobile Subscriber Identity) information stored in its IC card incorporating a CPU called an SIM (Subscriber Identity Module).

The user enters the other party's phone number into the mobile phone 103 to make a call. This call can be automatically made according to the software incorporated in the mobile phone 103. The mobile phone 103 is connected to the mobile phone base station 101 via the air interface 105. The mobile phone base station 101 is connected to a mobile phone base station 102 via a digital interface 106 such as an ISDN (Integrated Services Digital Network).

The mobile phone 104 sends updated information on its location to the mobile phone base station 102 so the mobile phone 103 is finally connected to the mobile phone 104 to enable a telephone conversation.

As in the case of the mobile phone 103 as mentioned above, the mobile phone 104 first sends updated information on its location to the mobile phone base station 102. In return, the mobile phone 104 receives from the mobile phone base station 102 the LAI and NITZ information of the mobile phone base station 102. For authentication, the mobile phone 104 sends the mobile phone base station 102 the IMSI information stored in its SIM.

For connection between a wire telephone and the mobile phone 103 or mobile phone 104, the mobile phone base station 101 or mobile phone base station 102 is connected to a PSTN (Public Switched Telephone Network) station 108 via a digital interface 106; when the wire telephone is connected to the PSTN station 108, it is connected with the mobile phone 103 or mobile phone 104.

An Internet service provider 109 is connected to the mobile phone base station 101 via a digital interface 110. The mobile phone 103 can receive various services depending on the content of the contract with the service provider 109. These services are provided as follows: using SMS-PP (Short Message Service Point-To-Point), SMS-CB (Short Message Service Cell Broadcast), GPRS (General Packet Radio Service) or the like, data is sent to the user and the user sends back his/her message, choice or the like. Service for access to web sites from the mobile phone 103 or mobile phone 104 is also available through a special gateway.

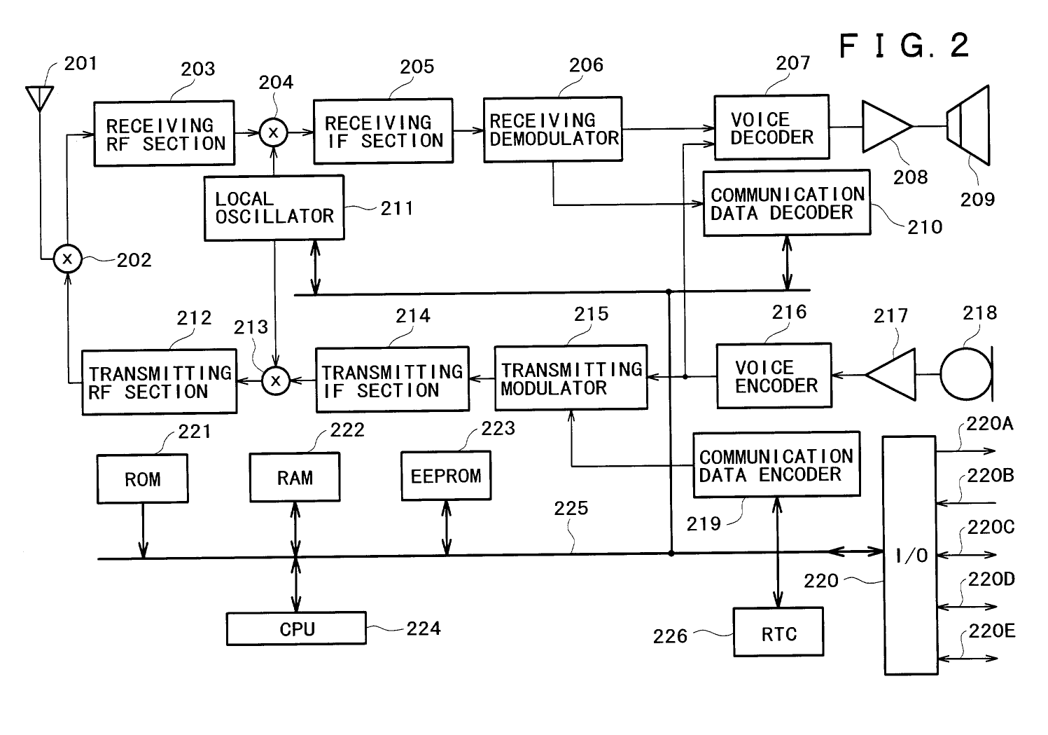

Next, the structure of a typical digital cellular mobile phone will be explained referring to FIG. 2. FIG. 2 is a block diagram showing the structure of a mobile phone as an example.

An input signal from an antenna 201 is led through a selector 202 into a receiving RF section 203 where a necessary step for band limitation such as AGC (Automatic Gain Control) is taken. Next, in order to convert a desired receiving frequency into a given frequency, the signal goes to a mixer 204 which mixes a signal from a local oscillator 211 and output from the receiving RF section 203.

The output from the mixer 204 enters a receiving IF section 205 where it is A/D converted into IQ digital data having a given bit rate. This IQ digital data goes to a receiving demodulator 206 which decodes the data properly through various processes such as elimination of the influence of fading, identification of the type of input signal, de-interleaving and error correction and separates it into voice data and communication data.

Voice data, which is usually in compressed form, is transmitted block by block where each received burst consists of a block. It is expanded and decoded in a voice decoder 207 and D/A converted according to the voice sampling rate. The analog signal as a result of the D/A conversion is amplified in a speaker amplifier 208 and sent to a speaker 209 to be outputted as a speech.

A specified word in a dictionary is usually pronounced or reproduced as a spoken word by sending voice synthesis data or sampled signal data to the voice decoder 207 which consists of a DSP (Digital Signal Processor), etc.

On the other hand, communication data, which has been separated by the receiving demodulator 206, is finally turned back into original data in a communication data decoder 210. The received data is sent on a CPU bus 225 from I/O 220 through a data I/F 220C to external equipment.

On the other hand, at the transmitting side, voice is converted into an analog voice signal through a microphone 218. Since the output level of the microphone 218 is low, the signal is amplified to a required voltage level in a microphone amplifier 217. In a voice encoder 216, the amplified voice signal is first A/D converted at an adequate sampling rate to become a digital signal. Speech input of words in a dictionary, etc. is made according to a speech recognition program stored in the voice encoder 216 which usually consists of a DSP. For a telephone conversation, the voice signal is encoded, compressed and made into blocks which are to match bursts in the RF.

Digital data entered through the data I/F 220V of the I/O 220 is made into blocks appropriately in a communication data encoder 219. Data from the voice encoder 216 and data from the communication data encoder 219 are combined in a transmitting modulator 215 to be converted into IQ digital data having a given data rate. This signal is D/A converted into an analog modulated signal in a transmitting IF section 214 and then mixed with a conversion signal from the local oscillator 211 in a mixer 213 so as to be converted into a signal with a desired transmitting frequency.

The signal whose frequency has reached the desired level is amplified in a transmitting RF section 212 to get the required transmitting power; then it passes through the selector 202 to be emitted from the antenna 201. A ROM (Read Only Memory) 221 stores the program to be executed by a CPU (Central Processing Unit) 224, as well as data for display fonts, etc. A RAM (Random Access Memory) 222, which allows access to any location in any order, is used to store data under computation as necessary while the CPU 224 is executing the program, or to temporarily store data which is being moved from the receiving side to the transmitting side or vice versa.

An EEPROM (Electrically Erasable and Programmable Read Only Memory) 223 is convenient for the user because, when the mobile phone is turned off, it stores, for example, setup parameters used until just before so that the same parameters are used when the power is turned back on.

An RTC (Real Time Clock) 226, which provides date (year, month, day) and time, is used for such purposes as time stamp on data, etc, mobile phone “World Clock” display, alarms and so on. The I/O 220, which is an interface with external equipment, provides interface for connection of a display 220A, keyboard/jog-dial 220B and data I/F 220C.

The jog dial can be moved in five ways: forward rotation, reverse rotation, dial push, front push and back push. An external storage I/F 220D is used in the following cases: for example, when using data from a memory stick or the like on the phone main body or when downloading large volumes of data for a dictionary or the like from the service provider 109 (FIG. 1), if the RAM 222 cannot process the data properly, it stores the data which the RAM 222 fails to process. An SIM I/F 220E is an interface with the SIM.

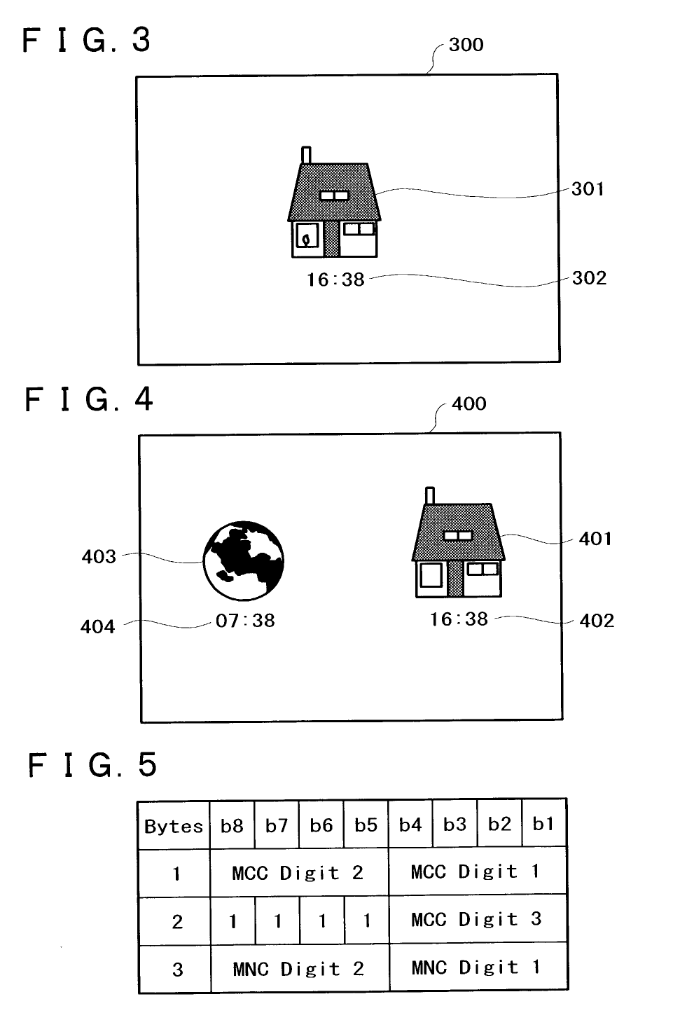

FIG. 3 is an example of a time display screen which usually appears on mobile radio terminal equipment. A Home City icon 301 on a display 300 suggests that the time indication refers to the standard or basic time for the user, or the clock time in the area where the user resides or a desired city for the user. Home time 302 indication shows the above-mentioned basic time for the user. The user of the mobile radio terminal equipment is kept informed of the basic time by looking at the Home time 302 indication below the Home City icon 301. In short, the mobile radio terminal equipment can be used as a clock.

FIG. 4 shows an example of a time display screen which appears when a time difference is detected according to an embodiment of the present invention. A World City icon 403 implies that there is a time difference. Local time 404 indication shows the clock time in the area whose time is different from the basic time for the user. A Home City icon 401 suggests that the time indication refers to the time, for example, in the area where the user resides and Home time 402 indication shows the time in the area. This example shows a screen after automatic time display change in the situation that mobile radio terminal equipment which is usually used in Japan is brought to, for example, the U.K. where the time difference from Japan time is nine hours (the U.K time is shown as Local time 404).

In this way, when an automatic time display change function as stated above is provided to show a local time, the user can easily check the time difference as necessary.

FIG. 5 shows an example of LAI (Local Area Identification) specification. Here, the LAI specification refers to part of the format of the LAI data from the base station 101 (FIG. 1) which is received by the mobile phone 103 and stored in the LAI file in its SIM. For detailed information, refer to ETSI (European Telecommunications Standards Institute) GSM (Global System for Mobile Communication) 11. 11. In the figure, MCC is an abbreviation for Mobile Country Code and MNC for Mobile Network Code.

In FIG. 5, the lower four bits of Byte 1 represent the most significant digit of MCC and its upper four bits represent the second digit of MCC; the lower four bits of Byte 2 represent the third digit of MCC and the upper four bits of Byte 2 represent a data delimiter. Byte 3 represents MNC which consists of two digits as expressed in the same way as for MCC. In the present invention, MNC is irrelevant. MCC shows in which country (or area) the user is.

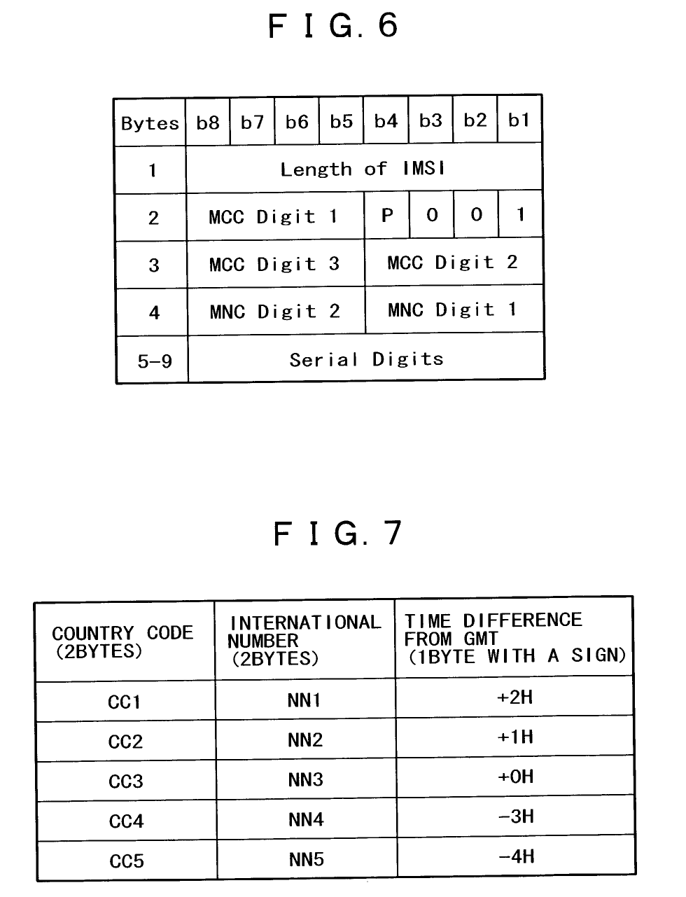

FIG. 6 shows an example of IMSI (International Mobile Subscriber Identity) specification. Here, the specification refers to an example of the format of IMSI data which is stored in the SIM of the mobile phone 103 (FIG. 1). (For detailed information, refer to ETSI GSM 11. 11.) In FIG. 6, Byte 1 expresses the total number of bytes of IMSI in encoded form; in this example, the number is 9. The lower four bits of Byte 2 are used for data check, etc. where P stands for parity. The upper four bits of Byte 2 represent the most significant digit of MCC. The lower four bits of Byte 3 represent the second digit of MCC and its upper four bits represent the least significant digit in MCC as a number of three digits. The lower four bits of Byte 4 represent the first digit of MNC and the upper four bits of Byte 4 represent the second digit (lower digit) of MNC. Bytes 5 to 9 represent a unique subscriber number issued to an individual subscriber at the time of sign-up.

FIG. 7 shows an example of a time difference table as used in the present invention. The table expresses MCC which is used in the present invention as well as the international number for the country or area represented by the MCC. Based on the MCC which is sent in return for updating of location information by the user side or the international number which is given when a call is made or received, the user can know the time difference from the Greenwich Mean Time (GMT, or international standard time). Referring to the table, for example, in case of country code CC1, the international number for that country or area is NN1 and the time difference from GMT is +2H. Likewise, in case of country codes CC2 to CC5, the international numbers are NN2 to NN5, respectively and the time differences from GMT are +1H, +0H, −3H and −4H, respectively. Although the table of FIG. 7 lists only five country codes, it is needless to say that more country codes are available.

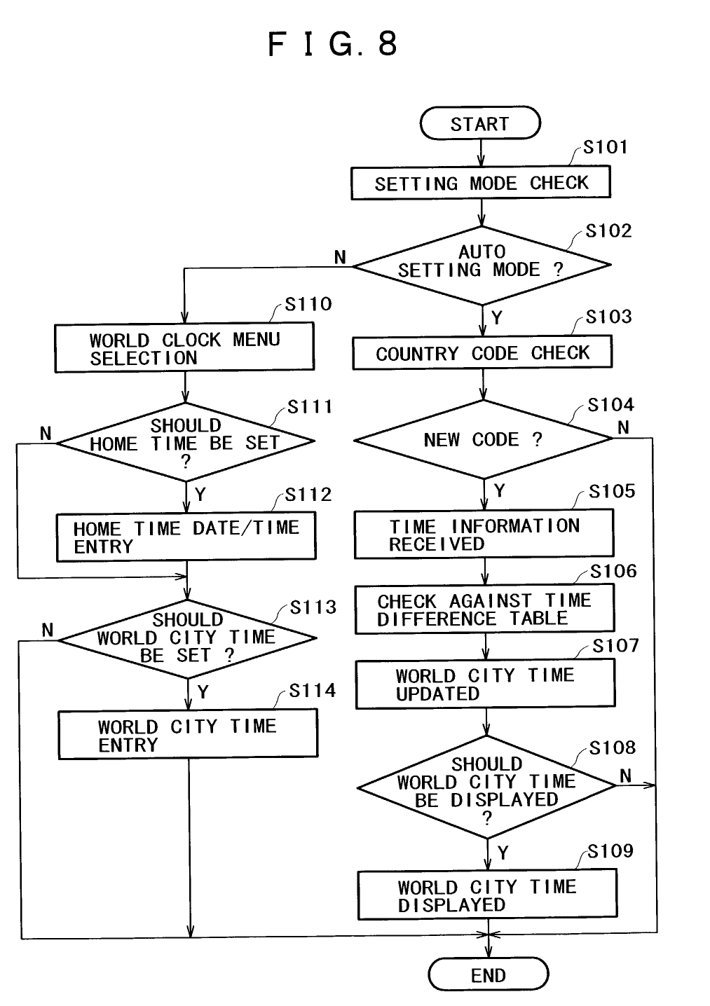

Next, the operation sequence required to practice a first aspect of the invention in the above-mentioned embodiment will be explained. FIG. 8 is a flowchart showing an example of a World Clock time setting and display operation sequence. The flow given in this figure includes choice as to whether or not the automatic change mode is to be used for the World City time indication.

As the user starts this menu (flow), a setting mode check is carried out at step S101, where, for example, a screen to choose whether the setting mode should be automatic or not appears. Next, if it is concluded at step S102 that the user has not chosen the automatic setting mode, World Clock menu selection is made at step S110, where options for manual time setting are displayed on the screen.

Then, if the option to set Home time is chosen at step S111, date and time entry for Home time is made at step S112. In this example, year, month, day and time for time setting are to be entered.

On the other hand, if the option not to set Home time is chosen at step S111, date and time entry for Home time at step 112 is skipped.

Next, at step S113, a choice is made as to whether World City time should be manually set or not. If the option to set World City time is chosen, time entry for World City time is made at step S113. If the option not to set World City time is chosen at step S113, time entry for World City time at step S114 is skipped. This concludes the manual time setting sequence (the flow is ended).

Contrariwise, if it is concluded at step S102 that the automatic mode has been chosen, first a country code check is made at step S103 in order to identify the area (country) where the mobile radio terminal equipment has updated its location information. If it is concluded at step S104 that the country code obtained by the country code check is the same as the current country code, or not a new code, the sequence is finished with no World City time updating (the flow is ended).

If it is concluded at step S 104 that the country code obtained at step S103 is a new country code, a process to receive time information from the base station is carried out at step S105. This process is not necessarily needed but useful for making a clock calibration with more accuracy.

Next, a check is made against the time difference table at step S106 in order to determine the time difference from GMT (international standard time) of the area where the user is. Taking GMT as the absolute time, local times relative to it can be determined from time differences of various areas from GMT, wherever around the world the user is. Based on the result of this check, World City time is updated at step S107.

Next, at step S108, a decision is made as to whether or not World City time should be displayed. If it is decided that World City time should not be displayed, the sequence is finished (the flow is ended). If it is decided that World City time should be displayed, World City time is automatically displayed in addition to Home time at step S109, which concludes the sequence (the flow is ended).

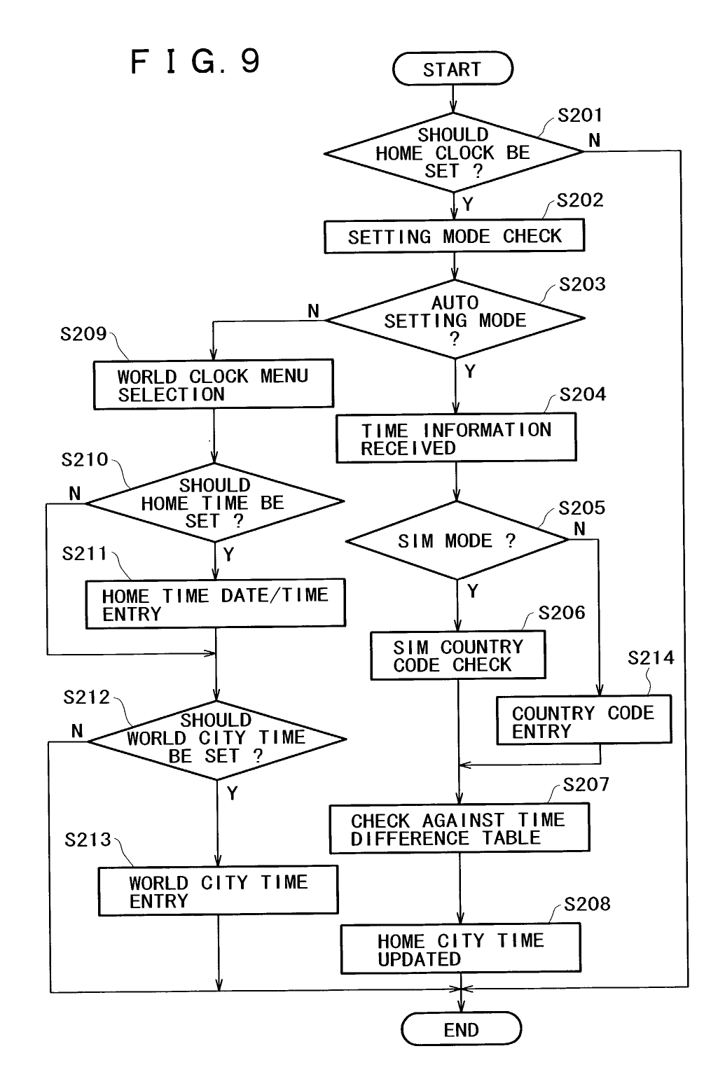

FIG. 9 is a flowchart showing an example of a Home Clock time setting sequence. Specifically, it shows the sequence of updating the Home City time displayed on the screen in the automatic mode or in the manual mode.

As the user starts this menu (flow), at step S201 a decision is made as to whether the Home Clock should be set or not. If no (Home Clock should not be set), the sequence is ended immediately (the flow is ended). If yes (Home Clock is to be set), a setting mode check is carried out at step S202, where, for example, a screen to choose whether the setting mode should be automatic or not appears.

Next, at step S203 a decision is made as to whether the automatic setting mode should be used or not; if no (it is decided here that the automatic setting mode should not be used), World Clock menu selection is made at step S209, where options for manual time setting are displayed on the screen.

Then, at step S210, a decision is made as to whether Home time should be set in the manual mode or not; if yes (it is decided here that Home time should be set in the manual mode), date and time entry for Home time is made at step S211, which is followed by step S212. In this example, year, month, day and time for time setting are to be entered.

On the other hand, if no (it is decided at step S210 that Home time should not be set), date and time entry for Home time at step 112 is skipped and followed by step S212.

Next, at step S212, a decision is made as to whether World City time, namely the local time in the area which the user visits, should set or not. If yes (it is decided that World City time is to be set), time entry for World City time is made at step S213, which concludes the time setting sequence (the flow is ended). If no (it is decided at step S212 that World City time should not be set), time entry for World City time at step S213 is skipped and the time setting sequence is concluded (the flow is ended).

If it is decided at step S203 that the automatic setting mode should be used, a process to receive time information from the base station is carried out at step S105. This process is not necessarily needed but useful for making a clock calibration with more accuracy. Then, in order to decide the reference which is used to determine Home City time, a decision is made at step S205 as to whether the SIM mode should be used or not.

In connection with the schematic diagram of FIG. 1 which shows a digital cellular system as an example, it has already been stated that the user's subscriber information from the operator with which the user has signed up is stored as IMSI information in the SIM. The IMSI information includes the country code which can be used to identify the area where the user is. Therefore, if it is decided at step S205 that the SIM information should be used, a SIM country code check is made at step S206, which is followed by step S207. If it is decided at step S205 that the SIM information should not be used, entry of the country code received from a base station is made at step S214, which is followed by step S207. If the country code is received from a base station in the area where the user is, reference is made to the information on that area.

At step S207, in either case, a check is made against the time difference table according to the country code. With this, the time difference from GMT is calculated and as a consequence, Home City time is updated at step S208 to determine the local time in the area where the user is. This concludes the sequence (the flow is ended).

The preferred embodiment of the present invention has been detailed so far; however the present invention is not limited thereto; the invention may be embodied in other various forms without departing from the spirit thereof.

For example, in the above-mentioned operation flow, the basic time for the user, or Home City time, is set based on the time difference which depends on the country code, or area code. However, if a mobile phone base station broadcasts information on local time in the area which it covers, it is also possible to set that local time as Home City time as it is.

Also, in the above preferred embodiment, a time difference is calculated from the basic time for the user, the area code sent from the mobile phone base station and so on; however, if the mobile phone base station broadcasts information on local time in the country or area in which the base station is located, it is also possible to use that local time information from the base station to calculate the time difference so that World City time is automatically displayed.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. Mobile radio terminal equipment with a built-in clock for time indication, comprising:
basic time storage means for storing basic time information;
display means for displaying time;
recognition means for recognizing time information for the current location of the mobile radio terminal equipment;
recognized time storage means for storing the time information recognized by the recognition means;
detection means for comparing the time information stored by the basic time storage means with the time information stored by the recognized time storage means and detecting a time difference if any; and
control means for performing automatic control so as to display on the display means both the basic time information and the time information for the current location when a time difference is detected by the detection means.

2. The mobile radio terminal equipment as claimed in claim 1, further comprising receiving means for receiving information from a base station, wherein the time information received by the receiving means at given time intervals is used as the current location time information for the recognition means.

3. The mobile radio terminal equipment as claimed in claim 1, further comprising:
receiving means for receiving information from a base station; and
table storage means for storing a table of time differences by area code,
wherein, according to the area code received by the receiving means at given time intervals, the time difference which corresponds to the received area code is read out from the table stored in the table storage means, and
time information based on the time difference read out is used as the current location time information for the recognition means.

4. The mobile radio terminal equipment as claimed in claim 1, further comprising
receiving means for receiving information from a base station,
wherein time information received by the receiving means is used as the basic time information.

5. The mobile radio terminal equipment as claimed in claim 1, further comprising:
receiving means for receiving information from a base station; and
table storage means for storing a table of time differences by area code,
wherein, according to the area code received by the receiving means, the time difference which corresponds to the received area code is read out from the table stored in the table storage means, and
time information based on the time difference read out is used as the basic time information.

6. The mobile radio terminal equipment as claimed in claim 1, further comprising:
table storage means for storing a table of time differences by area code,
wherein, according to the user residence area code stored in a subscriber card, the time difference which corresponds to the residence area code is read out from the table stored in the table storage means and the time information based on the time difference read out is used as the basic time information.
